(19) United States
(12) Patent Application Publication
(10) Pub. No.: US 2012/0249781 A1
(43) Pub. Date: Oct. 4, 2012

(54) Method consisting of pulsing a laser communicating with a gated-sensor so as to reduce speckle, reduce scintillation, improve laser beam uniformity and improve eye safety in laser range gated imagery

(76) Inventor: Richard Vollmerhausen, (US)

(21) Appl. No.: 13/079,047

(22) Filed: Apr. 4, 2011

(51) Int. Cl. H04N 7/18

(52) U.S. Cl. 348/135; 348/E07.085

(57) ABSTRACT

This invention discloses a method for pulsing a laser communicating with a gated-imager so as to improve the optical performance of active range-gated imagery. Multiple laser pulses are generated with the time between pulses determined by range ambiguity. The pulse width time and imager gate time determine the range gate. The focal plane array (FPA) is gated on and off multiple times to integrate signal from all of the pulses. Read out of the FPA is not initiated until the multiple pulses are received. Since FPA read out is not initiated until many pulses are integrated, the time between laser pulses can be short leading to the ability to integrate many pluses. Integrating many pulses reduces scintillation and speckle and allows the use of low power high repetition sources like laser diodes and diode pumped solid state lasers. Uniformity of the beam profile also improves.

### TECHNICAL FIELD

A method consisting of pulsing a laser communicating with a gated-sensor so as to reduce speckle, reduce scintillation, improve laser beam uniformity and improve eye safety in laser range gated imagery.

### FIELD OF INVENTION

This invention teaches and discloses a method for pulsing a laser communicating with a gated-sensor so as to optically improve the performance of active range-gated imagery. More specifically this invention teaches a method of optically improving the performance of gated imagers by utilizing multiple laser pulses and time-spaced gating of the imaging sensor so as to optically resolve an image in a range of distances while concurrently excluding light from nearer or further ranges from the gated-sensor.

Illumination results from any suitable laser, light emitting diode, flash lamp, arc lamp, or other means for emitting light. The laser might pump an optical parametric oscillator or any other suitable mechanism for modifying the wavelength or other properties of laser light. The method disclosed herein applies to any suitable hardware platform, such as is subsequently described hereinafter, that generates a pulse (brief in time) of light at any wavelength.

The gated-sensor is any one-dimensional or two-dimensional array of photo-detectors sensitive to the pulsed light illumination.

The method disclosed is applicable over a wide variety of hardware platforms as is further explained and disclosed.

### BACKGROUND OF THE INVENTION

There has been a long felt need to improve the efficacy of laser imaging technology by reducing speckle and the effect of scintillation on target imaging and acquisition. Further, achieving eye safety and uniform laser beam intensity constrain the design and increase the size and cost of active (laser) imaging sensors.

A laser range-gated imager is illustrated in FIG. 1. This arrangement is also known as a LIDAR (light detection and ranging). LIDAR is similar to radar except light is used in lieu of radio waves. Many LIDAR platforms are known to those skilled in the art.

LIDAR is used to determine range to the target in which case backscattered light is focused on a single detector. LIDAR is also used to form an image of the target. In this case the backscattered light is focused on a focal plane array of detectors.

A common term for imaging LIDAR is laser range gated (LRG) imager.

An LRG imager works by emitting a brief pulse of laser light that travels toward to the target. The light from flash lamps and light emitting diodes can also be used. The imager is gated off (does not detect light) for a period corresponding to the time of flight for light going to and from the target. So light scattered from intervening atmosphere, clouds, fog, dust, haze, etcetera does not degrade the contrast of the target image.

One primary benefit of an LRG imager is that it provides high-resolution, artificially illuminated imagery, while concurrently avoiding atmospheric backscatter from the intervening atmosphere. Backscatter from the atmosphere reduces target contrast and increases detector noise. Reduced contrast and increased noise reduce range performance.

Another benefit of LRG imaging (and therefore another benefit of the current patent proposal) is to “look past” intervening objects such as tree branches, wire fences, clouds, water and smoke.

Common hardware platform variations include both coherent and incoherent detection as well as using a single (monostatic) or separate (bistatic) aperture for an outgoing laser beam and for receiving backscattered light.

In practice an imager is gated ‘on’ in time to receive light from a target. A target image is formed on the focal plane array in the imager. After a period of time corresponding to the range gate, the imager is turned off. This process of ‘gating’ the imager has the optical effect of excluding light from objects or atmosphere closer or beyond the target so that those objects are not imaged.

The operation and benefits of LRG imagers described above are well known to those skilled in the art. Somewhat less well known are LRG imagers that use multiple bursts or pulses of light.

Multiple pulses are a way of increasing return signal by integrating multiple backscatters from a target. The typical practice is to operate the LRG imager multiple times forming multiple images. The images are then summed (“frame integrated”) in order to improve signal to noise and lesson speckle and scintillation.

Another practice using multiple pulses is pseudo noise coded imaging (PNCI). PNCI emits light in a maximal length shift register sequence (MLSRS). (MLSRS codes are one of several that are used in a similar method.)

PNCI pulse returns from different ranges are shifted in phase because of the extra time required for light to return from longer ranges. The MLSRS code is such that different phases of the same code are bi-orthogonal. It is therefore possible to develop images at different ranges using these (and similar) codes.

However, since light is collected from all ranges simultaneously, PNCI (and like imagers) do not avoid atmospheric backscatter. Also, the PNCI type LRG imager is sensitive to target or imager motion. Both of these variations on LRG imagers using multiple laser pulses are mentioned here to distinguish the current invention from previous practice. Those differences are explained and described in the Description of the Preferred Embodiment.

Disadvantages of LRG imagers are also well known to those skilled in the art. Disadvantages include laser speckle, non-uniform illumination due to scintillation, laser beam non-uniformity due to the use of multimode in order to get increased laser power, and eye safety hazards. Also, the high energy needed in single-pulse LRG designs limits both range and the number of LRG frames generated per second. The method disclosed abates or reduces these disadvantages so as to provide improved optical performance from a variety of hardware platforms.

Scintillation seriously degrades imagery because the target is not uniformly illuminated. After passing through the atmosphere, the laser illumination looks like a number of independent light sources, each with its own amplitude and phase. This lends a mottled effect to target illumination. In FIG. 2a (the left picture in figure), the target is uniformly illuminated. In FIG. 2b (to the right in the figure), illumination non-uniformity due to scintillation is illustrated.

Scintillation arises because of the coherent nature of laser illumination. Scintillation occurs after the light travels some distance through the atmosphere (the range depending on atmospheric turbulence, winds, etcetera), Scintillation depends on laser coherence and on turbulent properties of the atmosphere. Turbulent cells or eddies in the atmosphere occur because of temperature gradients, wind shear, any disturbance of a perfectly uniform atmosphere. Scintillation is reduced in three ways: a) by reducing laser coherence; b) by averaging images taken after the intervening atmosphere has shifted slightly; and c) by averaging multiple laser pulses that are not mutually coherent.

Speckle causes bright spots in the image. FIG. 3 illustrates speckle on the door and side of a truck. After reflecting from an object, the laser light becomes spatially incoherent because the object surface is rough. However, for near-normal surfaces and fairly smooth surfaces, the temporal coherence of the light causes speckle.

Unlike scintillation, the variation in target intensity caused by speckle occurs even at very short range. Speckle depends on laser coherence and on the angle and roughness of the target surface.

Another common problem in obtaining good LRG imagery is that lasers are operated in multimode in order to get increased output power. Multimode is where several transverse modes oscillate simultaneously. Multimode exploits a larger volume of the laser gain medium.

However, the multimode beam does not have a uniform intensity profile. Also, the laser beam profile varies between pulses because of mode-jumping. The result is non-uniform illumination of the target.

Eye safety, another factor in the design of laser systems, depends on many factors including the wavelength of the laser light and the size of the output aperture. In all cases, however, two power characteristics need to be limited. The first is the energy (joules) in a single pulse, and the second is the average power that might be seen by the eye. Typically, the pulse energy in joules per square centimeter of output aperture limits the amount of laser energy that can be used safely.

In order to improve LRG imager performance multiple FPA outputs can be integrated (frame integration). Integrating multiple frames averages out speckle and scintillation and averages the varying laser pulse profiles. However, typical CCD and other read out integrated circuits (ROIC) require several milliseconds to read out. Since a completely static scene cannot be assumed, integrating even a few frames is generally not practical.

Further, since only a few frames can be integrated, laser pulse energy cannot be much reduced from the single pulse case. This means that multiple laser pulses with about the same energy as a single pulse must be produced with only milliseconds separation between laser pulses.

The present invention is a method for pulsing lasers communicating with gated-sensor imagers so as to reduce speckle, reduce the effect of scintillation, and improve illumination uniformity, while concurrently providing increased eye safety. The technique also improves range performance and allows greater LRG imager frame rates using similar-sized hardware.

Multiple laser pulses spaced in accordance with the method disclosed provides superior imagery definition, speckle and scintillation reduction, and improved uniformity of the laser beam profile. The disclosed method also provides better eye safety, longer range performance, and increased LRG frame rates for the same aperture and system size,

The use of multiple pulses spaced in accordance with the method disclosed provides better beam uniformity because each pulse contains less energy and therefore fewer modes, and a number of pulses are averaged. Eye safety is improved by the decrease in per-pulse energy (fewer joules in each pulse). Reduced speckle is associated with the reduced spatial coherence that results from averaging a number of independently generated laser pulses. Reduced scintillation results from the movement of the atmosphere between the separate laser pulses and from the lack of spatial coherence between independent pulses. Improved range and increased frame rate result from using low-energy-per-pulse lasers with high repetition rates.

### BACKGROUND

### Description of the Prior Art

U.S. Pat. No. 7,667,824 issued to Moran discloses a range-gated sphearography system and related methods that includes at least one imaging detector coupled to a laser light source.

U.S. Pat. No. 7,449,673 issued to Chuang, et al discloses a system and method for reducing peak power of a laser pulse and reducing speckle contrast of a single pulse comprising a plurality of elements oriented so as to split a pulse or pulses transmitted from a light source.

U.S. Pat. No. 7,233,392 issued to Margalith, et al discloses spectral imaging device including a optical parametric oscillator that can be tuned across a wide range of wavelengths while illuminating a target.

None of the prior art taken individually or collectively disclose and teach a method consisting of pulsing a laser communicating with a gated-sensor so as to reduce speckle, reduce scintillation, improve laser beam uniformity and improve eye safety in laser range gated imagery.

### OBJECTS AND ADVANTAGES OF THE INVENTION

A method is disclosed for pulsing a laser communicating with a gated-sensor means providing superior imagery definition, reduced speckle and scintillation and improved uniformity of the laser beam profile is achieved.

Another object and advantage of the method is that of improving eye safety by reducing per-pulse laser energy.

Another object and advantage of the method disclosed is applicability over a wide variety of laser-gated sensor platforms and applications. The method retains all of the advantages of traditional LRG imagery.

A still further object and advantage of the invention is that the method disclosed provides a means for using low power, high repetition rate lasers (for example laser diodes and diode pumped solid state lasers) to achieve long range LRG imagery at high frame rates.

### BRIEF DESCRIPTION OF THE DRAWINGS

FIG. 1 is a schematic of LRG imager illustrating light traveling to and from a target. The range gate R_{G} and ambiguity distance D_{A} are also illustrated.

FIG. 2 (a) is a photograph of a target uniformly illuminated using a spotlight.

FIG. 2b shows the same target illuminated using a laser through kilometers of atmosphere. Scintillation causes the laser illumination to be non-uniform giving the target a mottled appearance.

FIG. 3 shows speckle on the door and side of a truck.

FIG. 4 shows an image intensified CCD imager. The I² tube operates in the ultraviolet through short wave infrared (SWIR) depending on the cathode material. When the MCP is used these are 2^{nd} through 4^{th} generation devices. Without the MCP the I² is a 1^{st} generation device. Any generation I² can be used in a LRG imager.

FIG. 5 is a schematic of an imager using a focal plane array (FPA) without the I² tube. In this case, gating occurs on the FPA itself.

FIG. 6 is a schematic of an imager using a FPA inserted into an I² tube. Placing the FPA inside the tube has certain advantages like being able to gate the tube and making the I² tube plus FPA smaller in size than the arrangement shown in FIG. 4.

FIG. 7 is a timing sequence when using an I² tube. The top sequence is for one laser pulse in a sequence of I_{number} pulses.

FIG. 8 illustrates timing when using a FPA without an I² tube.

### DESCRIPTION OF THE PREFERRED EMBODIMENT

The invention disclosed is a method for achieving improved optical results from lasers communicating with a gated sensor imager. The method disclosed consists of the specific technical specifications in that one skilled in the art of laser and imaging technologies has the technological skill and the equipment means for regulating the technical parameters necessary to achieve the objects and advantages of the method.

The method then is one of specifying a laser pulse rate in combination with a gated imager means rather than a specified ‘step’ procedure. The results of the invention are obtained not so much from a one-two-three procedure, but from implementing the equations given in combination with at least one laser communicating with a gated imager. The invention resides in the equations in combination with a means for implementing the method disclosed.

The following provides both examples of the hardware means necessary for implementing the method and also provides the equations and the science necessary for successful implementation of the method.

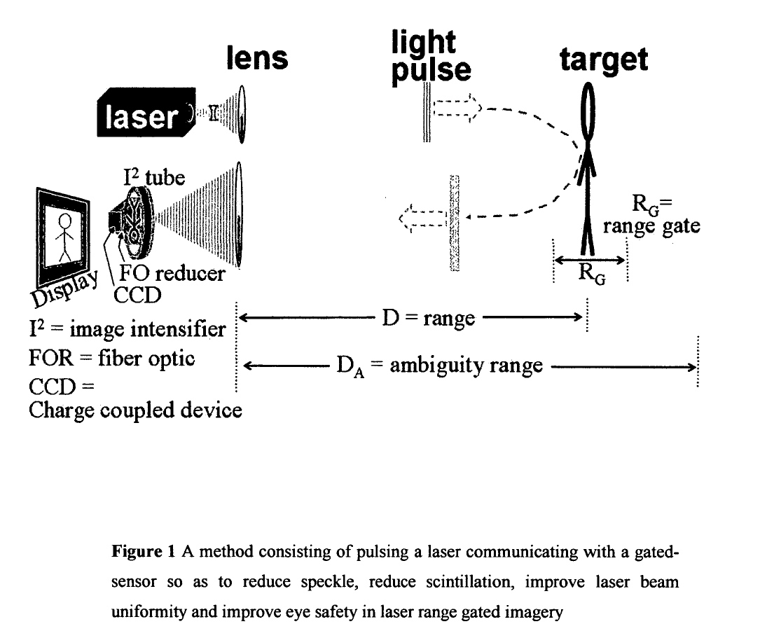

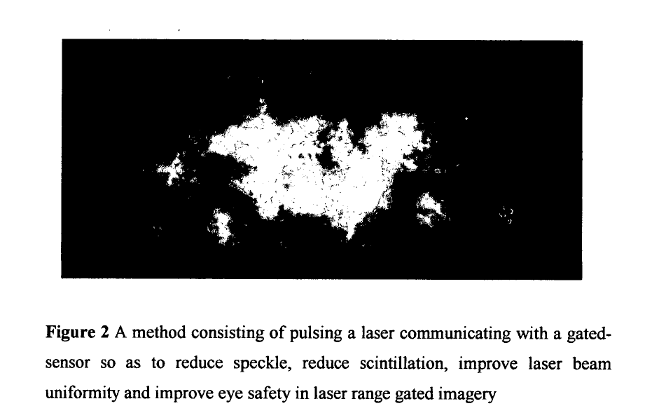

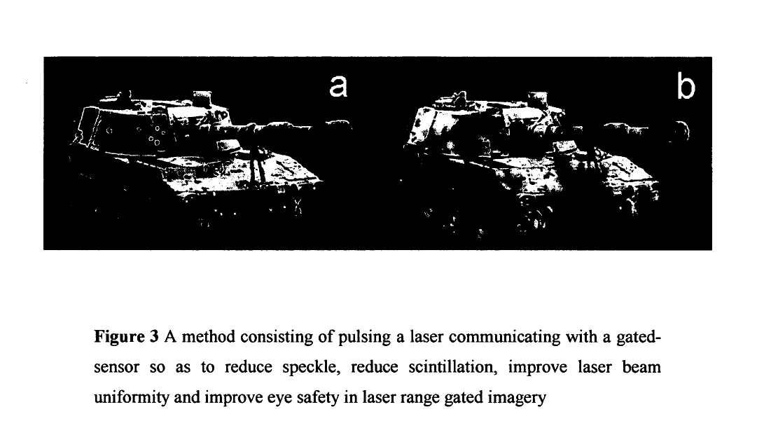

The example in FIG. 1 operates at a wavelength near 1.5 microns in order to achieve eye safety with large laser peak pulse power. Operating in the ultraviolet at 0.355 microns also provides good eye safety. Operating at intervening visible and near infrared wavelengths between 0.4 and 1.4 microns requires using much less laser power and much less energy in each laser pulse.

Light pulses can be generated using lasers, laser diodes, flash lamps, or light emitting diodes. In this example, the laser pulse is generated using an optical parametric oscillator (OPO) pumped by a Q-switched Nd containing material (Nd: YAG, Nd: YLiF, or Nd:YVO4). In previous art, pulse rates of one or two per second are achieved using a flash lamp pumping a Nd laser. In this example, the per pulse power is much lower and diode pumped lasers are used to generate a high repetition rate with lower per pulse joules (energy).

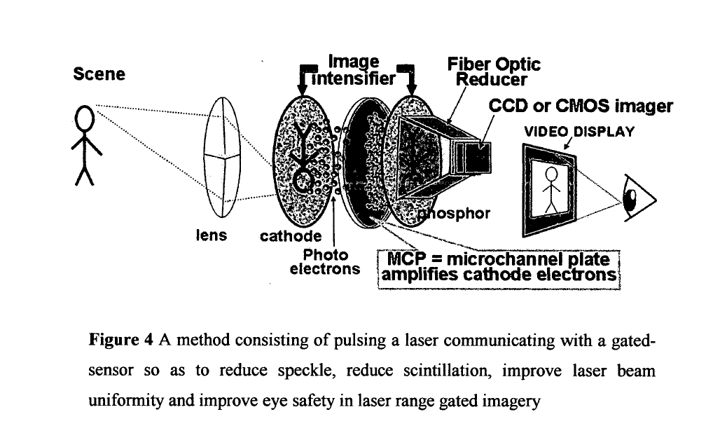

See FIG. 4. An I² tube using a InGaAs/InP (at 1.5 microns) cathode is used because it provides low noise amplification and also because it can be quickly gated. The I² tube forms an image of the scene on its phosphor screen. The fiber optic reducer couples the I² image to the CCD FPA. The CCD is needed to form an electronic image for remote display.

The laser is pulsed in accordance with the following specifications. The CCD charge (signal) is dumped and the CCD gated on. The laser is pulsed many times and the I² tube gated on many times such that the CCD integrates the signal from many laser pulses. Only after tens, hundreds, or thousands of pulses have been integrated, only then is the CCD readout implemented and an image displayed. The cycle is then repeated.

During the entire sequence from [057] through [061], the CCD is gated on and is integrating light from the I² tube. Let c be the speed of light in meters per second. Let range to a target be D meters. A multitude of laser pulses are generated and the I² tube gated on per [058] through [060] to receive reflected laser light.

The time between light pulses is a minimum of G_{off}

G_{off}=2D_{A}/c seconds Eq. 1

where D_{A} is the ambiguity range in meters. (In FIG. 1, D_{A} is not to scale.) A sufficiently large D_{A} ensures that light from a previous laser pulse does not enter the sensor range gate. If previous pulses are detected, the target that is reflecting the previous pulse appears to be at a much closer range than actuality.

Let tₚᵤₗₛₑ seconds represent the laser pulse length. In order to ensure that all of the return pulse energy is captured, the gated-sensor on-time must be at least tₚᵤₗₛₑ. In order to capture all of the laser pulse energy from targets over the distance R_{G} meters, the gated-sensor (in this case I² tube) gate on-time (Gₒₙ) is

Gₒₙ=tₚᵤₗₛₑ+2R_{G}/c seconds. Eq. 2

In order to capture all the laser pulse energy from a target at the front edge of R_{G}, the gate delay (G_{delay}) from the front edge of the light pulse to gate on is

G_{delay}=2D/c−R_{G}/c seconds Eq. 3

where the target is assumed to be at the center of the range gate. That is, the range gate R_{G} is centered at range D from the imager.

The laser is pulsed on many times and the I² tube gated on many times, presenting the many gated images to the CCD. The CCD integrates all of the images.

After a sequence of many light pulses, the gated-sensor (a CCD in this case) is read out to the display. Let tₘₒₜᵢₒₙ be the total time that light pulses are integrated by the gated-sensor. Based on typical video rates, tₘₒₜᵢₒₙ is likely to be between 0.0167 and 0.02 seconds, although these times might be shorter or longer based on application. The number of light pulses is L_{number}

L_{number}=integer(tₘₒₜᵢₒₙ/G_{off}) Eq 4

To summarize, the CCD pixels are cleared and then the CCD set to image the output of the I² tube. Tens, hundreds, or thousands of laser pulses are generated. The number depends on the desired signal to noise and on image motion. Generally, the CCD is allowed to integrated for perhaps 1/60^{th} of a second. For 1/60^{th} second CCD integration, L_{number} equals 0.0167/G_{off}. The laser pulses are spaced G_{off} seconds apart. The I² tube is gated on for Gₒₙ seconds after each pulse with a delay of G_{delay} seconds from the beginning of the laser pulse. After the sequence of laser pulses and I² tube gating is complete, the CCD image is read out and a new sequence initiated.

An I² tube and CCD or CMOS FPA in combination is one example of gated-sensor. Many options exist to form an image from returning laser pulse light. For example, the CCD or CMOS alone can be used in the ultraviolet, visible, and near infrared spectral bands. In this case, the CCD exposure control is gated on in lieu of the I² tube. Generally, the exposure control is electronically connected such that stopping exposure initiates readout. This sequence must be disabled, such that multiple CCD exposures occur prior to initiating CCD readout.

Avalanche photo diode (APD) arrays are also used. At longer wavelengths, especially at the eye safe 1.5-micron spectral region, several other options also exist. These include HgCdTe APD FPA and InGaAs FPA.

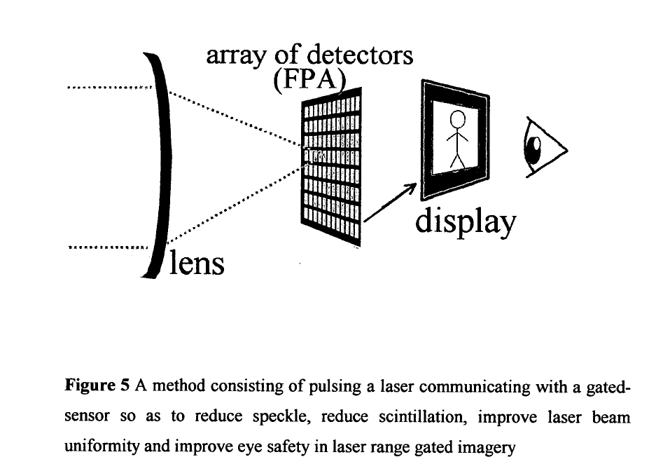

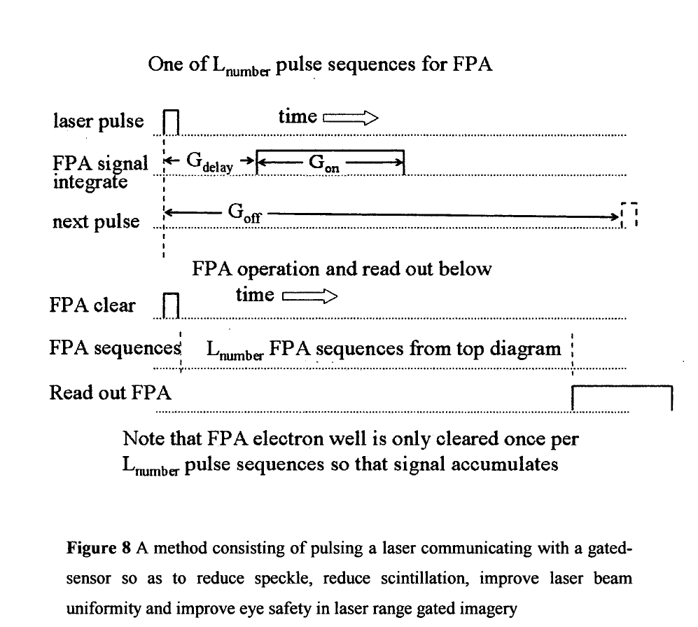

An imager and FPA are shown in FIG. 5. When using the FPA without the I² tube, photo detector elements on the array are gated on and off. The timing sequence is shown in FIG. 8.

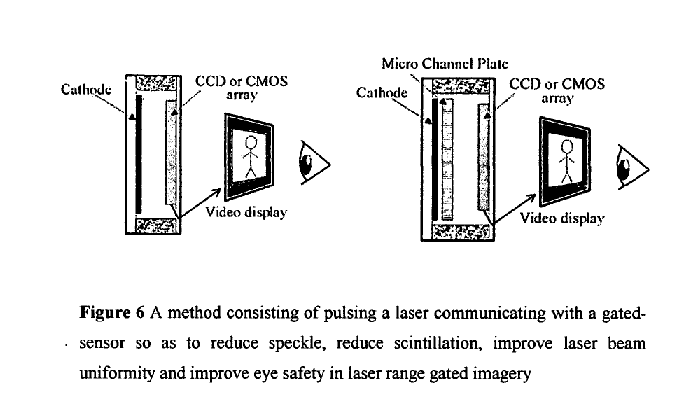

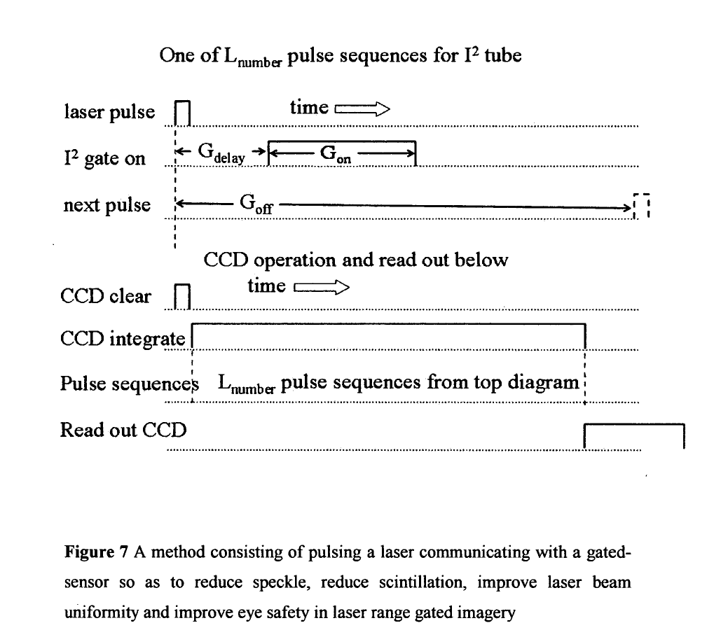

Alternatively, some manufacturers put the CCD or CMOS imager inside an image intensifier vacuum so that electron multiplication due to electron bombardment (EB) occurs directly on the silicon FPA. See FIG. 6. The timing in FIG. 7 applies to these devices.

The use of many laser pulses to create each image reduces speckle, reduces the effect of scintillation, improves laser beam uniformity, and improves eye safety. These advantages accrue regardless of the type of laser or imager used. The use of an OPO pumped by an Nd-containing laser is just an example. The LRG concept applies to LRG imagers using any type of laser, laser diode, LED, or flash lamp illumination. Lasers can be solid state, gas, or dye. Pumping can be by flash lamp or solid-state diodes. The use of the I²/CCD is also just an example. Any type of gated imager can be used in the preferred implementation.

Using multiple laser pulses, in the method disclosed, is a way of increasing return signals by integrating multiple backscatters from the target.

Goff is typically tens or at most hundreds of microseconds and imaging FPA require at least milliseconds to read out. This means that the method for reducing speckle, reducing the effect of scintillation and improving laser beam uniformity and improving eye safety in laser range gated imagery allows integrating many more laser pulses than is possible by integrating CCD frames.

For any type of FPA, one of the major noise sources is readout or amplifier noise. Since the preferred implementation calls for readout only after integrating multiple laser pulses, the impact of readout and amplifier noise is reduced.

Also, technology permits generating more total power when summing many pulses. This together with the improved intensity profile and reduced speckle and scintillation of the disclosed methodology provides significant range performance benefit when compared to a single pulse implementation.

Further, the use of low-energy-per-pulse, high repetition rate lasers permits operation of the LRG imager at the full 60 Hertz (or higher) rate of the FPA/I²CCD imager. This means that images of 60 or more different range gates can be obtained each second.

What is claimed is:

1. A method consisting of pulsing a laser communicating with a gated-sensor so as to reduce speckle, reduce scintillation, improve laser beam uniformity and improve eye safety in laser range gated imagery:
a) Light pulses can be generated using lasers, laser diodes, flash lamps, or light emitting diodes;
b) The laser might pump an optical parametric oscillator or any other suitable mechanism for modifying the wavelength or other properties of laser light;
c) The gated-sensor is any one-dimensional or two-dimensional array of photo-detectors sensitive to the pulsed light illumination;
d) The time between light pulses is a minimum of G_{off}
G_{off}=2D_{A}/c seconds
where D_{A} is the ambiguity range in meters and c is the speed of light;
e) Let tₚᵤₗₛₑ seconds represent the laser pulse length;
f) Gated-sensor gate on-time (Gₒₙ) is
Gₒₙ=tₚᵤₗₛₑ+2R_{G/c seconds}
where R_{G} is the range gate in seconds;
g) The gate delay (G_{delay}) from the front edge of the light pulse to gate on is
G_{delay}=2D/c−R_{G}/c seconds;
h) After a sequence of many light pulses, the gated-sensor is read out to the display;
i) Let tₘₒₜᵢₒₙ be the total time that light pulses are integrated by the gated-sensor;
j) The number of light pulses is L_{number}
L_{number}=integer(tₘₒₜᵢₒₙ/G_{off}).

2. Many options exist to form an image from returning laser pulse light:
a) An I² tube and CCD or CMOS FPA in combination is one example of gated-sensor;
b) The CCD or CMOS alone can be used in the ultraviolet, visible, and near infrared spectral bands;
c) Avalanche photo diode (APD) arrays are also used;
d) Other options include HgCdTe APD FPA and InGaAs FPA;

3. A method is disclosed for pulsing a laser communicating with a gated-sensor means providing:
a) Superior imagery definition;
b) Reduced speckle and scintillation;
c) Improved uniformity of the laser beam profile;
d) Improving eye safety by reducing per-pulse laser energy;
e) Applicability over a wide variety of laser-gated sensor platforms and applications;
f) All of the advantages of traditional LRG imagery;
g) A means for using low power, high repetition rate lasers (for example laser diodes and diode pumped solid state lasers) to achieve long range LRG imagery at high frame rates.
